(19) United States
(12) Patent Application Publication
(10) Pub. No.: US 2013/0038674 A1
(43) Pub. Date: Feb. 14, 2013

(54) SYSTEM AND METHOD FOR DISTRIBUTING AND INTERACTING WITH IMAGES IN A NETWORK

(71) Applicants: James Michael Woods, Toronto (CA); Alexander Louis Christodoulou, Toronto (CA)

(72) Inventors: James Michael Woods, Toronto (CA); Alexander Louis Christodoulou, Toronto (CA)

(73) Assignee: XTREME LABS INC., Toronto (CA)

(21) Appl. No.: 13/568,746

(22) Filed: Aug. 7, 2012

Related U.S. Application Data
(60) Provisional application No. 61/521,093, filed on Aug. 8, 2011.

(51) Int. Cl. H04N 7/14

(52) U.S. Cl. 348/14.08; 348/E07.077

(57) ABSTRACT

A method is provided for receiving and interacting with a set of presentation images by a user on a mobile device, during a presentation given by a presenter to a plurality of participants. The presentation images are received on the mobile device from a presentation server. A first display instruction is also received from the presenter via the server. The presentation images (rendered locally on the mobile device) are displayed through an interactivity interface on the device taking into account the first display instructions as permitted by the capabilities of the mobile device. When a second display instruction is received from the presenter via the server the appearance or pacing of the presentation images is automatically changed on the interactivity interface without the need to reload the presentation images from the presentation server.

### CROSS REFERENCE TO RELATED APPLICATION

This application claims priority from U.S. Provisional Application No. 61/521,093 filed on Aug. 8, 2011, which is incorporated by reference in its entirety herein.

### TECHNICAL FIELD

The present invention relates to a network based system and methods for distributing and interacting with images in a network, and more particularly to permit presentation of, and interaction with slides over a network, while permitting control of, or interaction with, the presentation via mobile devices.

### BACKGROUND

A presentation program is a computer software used to display information, often in the form of a slide show. It typically includes three major functions: (a) an editor that allows text to be inserted and formatted, (b) a method for inserting and manipulating graphic images and (c) a slide show system to display content.

Although well established, traditional presentation methods which utilize a presentation program have a number of significant shortcomings: (a) They are over-dependent on a single computer, typically a laptop or desktop machine, which can often become a single point of failure. (b) They are limited in their portability and flexibility while requiring dedicated installation areas and necessitating common presentation host-audience dynamics. For example, such systems of assume that everyone is in the same room, the presenter stands up front, communication is verbal, and slides are shown from the front of the room. (c) They do not provide for interaction with mobile devices.

### SUMMARY

According to a first aspect of the invention, a method is provided for receiving and interacting with a set of presentation images by a user on a mobile device, during a presentation given by a presenter to a plurality of participants. A set of presentation images is received on the mobile device from a presentation server. The device also receives a first display instruction from the presenter via the server. The presentation images are displayed through an interactivity interface on the device taking into account the first display instructions as permitted by the capabilities of the mobile device. The presentation images are rendered locally on the mobile device. The device receives a second display instruction from the presenter via the server and changes the appearance or pacing of the presentation images displayed on the interactivity interface without reloading the presentation images from the presentation server.

The first and second display instructions may include, for example, instructions related to an order or playback of the presentation images, highlighting of a portion of an image, or initiating a playback of a multimedia component.

Ancillary material from the presenter may also be received on the device. The ancillary material is preferably rendered as an overlay on at least one of the presentation images displayed on the interactivity interface. For example, the ancillary material may include at least one of a graphical image, text, multimedia component, photograph, voice or video call. Any of these may be generated at least in part by the presenter during the presentation. Preferably, the ancillary material does not require reloading the presentation images on the device.

Messaging from the presenter or a participant may also be received on the device during the presentation while the presentation images are being displayed. For example, the messaging may include a text message, a vibrate signal, a voice or video call. Preferably, the messaging does not obscure (or interrupt) the presentation image being displayed. The messaging may be received as a broadcast across a plurality of participant devices. Alternatively, the messaging may be received as a private, one-to-one message.

The interactivity interface preferably also allows the user to input certain things on the device while the presentation images are being displayed. For example, depending on the device capabilities (and permissions that may be set for participants), the user may be able to input a message, a highlight of an item on the presentation images, a graphical image or multimedia component generated by the user during the presentation. The input may include a request to transmit the input to the presenter, or another participant. The input may alternatively include a request to broadcast the input to all of the participants. In one embodiment, the input is received via a touch screen on the device. (Other forms of input are also possible using the microphone, camera, keyboard, keypad, or other input or receiving capabilities of the mobile device.) Preferably, the input appears as an overlay with the presentation image on the user's device while the input is being generated by the user. Preferably, the input does not alter the local copy of the presentation images.

It will be appreciated that other messaging, ancillary materials and display instructions may also be input (by the presenter or other participants) using other mobile devices, and their respective input or receiving capabilities.

### BRIEF DESCRIPTION OF THE FIGURES

FIG. 1 is a sample network diagram illustrating the relationship of client devices, a central server, external servers, a first network, and a second (more comprehensive) network.

FIG. 2 is a sample network diagram illustrating a preferred embodiment of the present invention where the presentation host is using a smartphone and the presentation is a slide show. Its flow is being controlled by the host using left-right finger swipe motion on a touch display. In this illustration, two slides are in transition as the host causes their movement.

FIG. 3 is a sample network diagram where the presentation host is touching a point on the smartphone, depicted in the lower image, causing the audience's device to display a visual cue at the equivalent location.

FIG. 4 is a sample network diagram where the presentation host selects and nudges a participant using the smartphone's vibrate feature.

FIG. 5 is a sample network diagram where participants communicate using text chat.

FIG. 6 is a sample network diagram of an interactive whiteboard session in progress. One participant is drawing a circle around a particular area of the slide. Bidirectionality is device dependent; a projection screen does not have user input.

FIG. 7 is a sample network diagram illustrating possible multimedia capabilities of the present system. In this particular case, both a video is being played while the host is conducting a video chat utilizing the smartphone's front facing camera.

FIG. 8 is a sample network diagram illustrating a question and answer session. The audience poses their questions or remarks to the host using their devices where input is available. The responses are displayed in the host's device.

FIG. 9 is a flowchart of user interactions according to a possible embodiment of the present method. It includes all core use cases of (a) login/logout, (b) create an account that allows creating and conducting presentations, (c) create and manage a presentation, (d) conduct a presentation, (e) view a presentation as either host or audience. As shown, use cases (a) to (d) are preferably limited to registered hosts (presenters).

### DETAILED DESCRIPTION

Based on market trends such as growth of online social media, it would be beneficial to provide a novel type of storage and real-time presentation tool which utilizes a common mobile device as, inter alia, (a) the center point and control mechanism, (b) the vehicle to facilitate interaction among participants in a presentation of images.

Before embodiments of the invention are explained in detail, it is to be understood that the invention is not limited in its application to the details of the examples set forth in the following descriptions or illustrated drawings. The invention is capable of other embodiments and of being practiced or carried out for a variety of applications and in various ways. Also, it is to be understood that the phraseology and terminology used herein is for the purpose of description and should not be regarded as limiting.

Before embodiments of the software modules or flow charts are described in detail, it should be noted that the invention is not limited to any particular software language described or implied in the figures and that a variety of alternative software languages may be used for implementation of the invention.

It should also be understood that many components and items are illustrated and described as if they were hardware elements, as is common practice within the art. However, one of ordinary skill in the art, and based on a reading of this detailed description, would understand that, in at least one embodiment, the components included in the method and tool are actually implemented in software.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. Computer code may also be written in dynamic programming languages that describe a class of high-level programming languages that execute at runtime many common behaviors that other programming languages might perform during compilation. JavaScript, PHP, Perl, Python and Ruby are examples of dynamic languages. Additionally computer code may also be written using a web programming stack of software, which may mainly be comprised of open source software, usually containing an operating system, Web server, database server, and programming language. LAMP (Linux, Apache, MySQL and PHP) is an example of a well-known open-source Web development platform. Other examples of environments and frameworks in which computer code may also be generated are Ruby on Rails which is based on the Ruby programming language, or node.js which is an event-driven server-side JavaScript environment.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

In the present invention, the client device enables a user to engage with an application using the invention. This device preferably includes a memory for storing a control program and data, and a processor (CPU) for executing the control program and for managing the data, which includes user data resident in the memory and includes buffered content. The device may be coupled to a video display such as a television, monitor, or other type of visual display while other devices may have it incorporated in them (iPad). An application or a game or other simulation may be stored on a storage media such as a DVD, a CD, flash memory, USB memory or other type of memory media or it may be downloaded from the internet. The storage media can be inserted to the console where it is read. The console can then read program instructions stored on the storage media and present a user interface to the user.

In some embodiments, the device is portable. In some embodiments, the device has a touch-sensitive display with a graphical user interface (GUI), one or more processors, memory and one or more modules, programs or sets of instructions stored in the memory for performing multiple functions. In some embodiments, the user interacts with the GUI primarily through finger contacts and gestures on the touch-sensitive display. In some embodiments, the functions may include providing maps and directions, telephoning, video conferencing, e-mailing, instant messaging, blogging, digital photography, digital videoing, web browsing, digital music playing, and/or digital video playing. Instructions for performing these functions may be included in a computer readable storage medium or other computer program product configured for execution by one or more processors.

It should be understood that although the term application has been used as an example in this disclosure but in essence the term may also imply to any other piece of software code where the embodiments of the invention are incorporated. The software application can be implemented in a standalone configuration or in combination with other software programs and is not limited to any particular operating system or programming paradigm described here. Thus, this invention intends to cover all applications and user interactions described above as well as those obvious to persons skilled in the art.

The computer program includes: a computer usable medium having computer usable program code, the computer usable program code includes: computer usable program code for presenting graphically to the users options for scrolling via the touch-screen interface.

The device may include but not limited to a personal computer (PC), which may include but not limited to a home PC, corporate PC, a Server, a laptop, a Netbook, a Mac, a cellular phone, a Smartphone, a PDA, an iPhone, an iPad, an iPod, a PVR, a set-top box, wireless enabled Blu-ray player, a TV, a SmartTV, wireless enabled Internet radio, e-book readers e.g. Kindle or Kindle DX, Nook, etc. and other such devices that may be used for the viewing and consumption of content whether the content is local, is generated on demand, is downloaded from a remote server where is exists already or is generated as a result. Source Device where content is located or generated and Recipient Device where content is consumed may be running any number of different operating systems as diverse as Microsoft Windows family, MacOS, iOS, any variation of Google Android, any variation of Linux or Unix, PalmOS, Symbian OS, Ubuntu or such operating systems used for such devices available in the market today or that will become available as a result of the advancements made in such industries.

Presentations refer to the output of a computer software package used to convey information frequently in the form of a slide show. The host is defined as a person performing the presentation. The audience members are defined as persons who receive the presentation. Participants may include the host and audience.

The present invention includes systems and methods. The system includes a network connected server that permits hosts to store and access presentation data though a secure means using supported equipment such as computers or mobile devices. The system also includes network connected equipment such as computers and mobile devices that permits the presentation host and audience to access the data. The present method provides means, inter alia, to control the presentation and for participants to remotely interact in real time, and permits virtual presentation and participation in said presentations. The invention permits presentations and other images to be made from any device to any device regardless of the type and form factor of the devices. For example, the presenter (host) and participants may participate in the presentation via mobile devices (e.g. smartphones).

The technology is preferably implemented via a server that is implementing an application allowing selective multicasting to devices (in one embodiment, using Node.js). The presenter sends the presentation (e.g. as a PDF or PPT) to the server which then sends it to the participants. Each participant has a local copy on his/her device. Changes (highlight, scribbles etc.) made by any of the participants or the presenter are converted to instructions that are sent to the server, which then sends the instructions to the other devices (e.g. as a text that can be rendered locally to show the change). Similarly when the presenter changes pages, they are dealt in a similar way. The word “change” is used here figuratively, since although the appearance of the images on the device (or their manner of being displayed) may change, the local copy of the images does not change (and thus does not need to be refreshed or reloaded).

The person who initiates the presentation (host) may have special permissions which other viewers do not. When a presentation is first started there is preferably a small “handshake” between the server and the presenter's device which delivers a key to the presenter and lets the server know which device is communicating. Any presenter action would then use this key. Viewers (participants) would have a similar set up with their own different keys. Only a user having the right key would have permission to view/present that presentation.

The present invention has the following features and benefits in preferred embodiments: (a) hybrid network-based technology allowing for traditional presentation models, (b) cloud and centralized storage options allowing for redundant control mechanism, (c) integration with web-based social media, (d) cross-platform solution encompassing mobile devices, (e) thorough mobile integration of presentation technology.

In (a), a hybrid web-based technology aspect, the present invention uses a server-based presentation controller and user transaction modules acting across a network. These server modules may intermediate actions between participants using a push model. In this embodiment, presentation participants have a network connection which is utilized to navigate to the unique network address of the presentation. Actions are present that allow the host to assign a unique network address to presentations. Depending on configuration, participants may securely log in. In the preferred embodiment, the network is the Internet. Presentation material is refreshed as needed rather than constant polling.

In (b), a cloud centralized storage aspect, the presentation host is provided direct means to upload content (including images) to a central server. There is also an option in a different embodiment to connect to Internet based services that provide an API such that content can be pulled from their servers. Once in the designated storage space by either method, the content is available for presentation and can be managed.

In (c), a social media aspect, the present invention can be accessed at will for those with rights according to configurable business logic, such that hosts can, inter alia, announce their presentation and provide a hyperlink to it on popular Internet services.

In (d), a cross-platform aspect, the present invention supports desktop web browser clients and a broad range of mobile devices for both host and audience. Bidirectional audio and video is transmitted where support is available. In a preferred embodiment static presentations, such as Powerpoint presentations can be converted to more commonly supported image types, such as PDF.

In (e), a true mobile integration aspect, smartphones are used in the preferred embodiment. The present invention can thus exploit features that are standard on smartphones. Among these features are a touch screen display linked to software control, a vibrate mode and an ability to accept socket connection to push data.

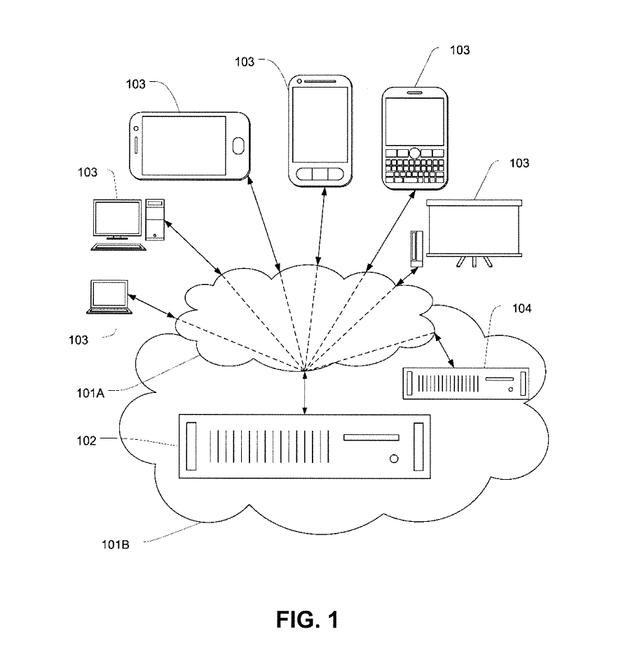

The network and cross platform embodiments (a) to (d) are illustrated in FIG. 1. The network 101A connects a central server 102 with one or more client devices 103 and external servers 104 for Internet based services. The role of the central server 102 in the present invention is to permit presentation control and intermediate transactions among client devices. The presence of the central server and other servers during a presentation is largely invisible and transparent to the devices 103. From the users' (participants') viewpoint the presentation delivery appears to be simply part of a more comprehensive network 101B which, in the preferred embodiment, is the Internet.

In a preferred embodiment, an event driven, server-side programming environment such as Node.js is used for server intermediated aspects of the present invention. Key aspects include the connection between the central server 102 and host/audience devices 103, the latter usually as one to many. Another key aspect is signalling. Signals required for functionalities in the present invention such as synchronizing the display of slides across all participants, applying a laser pointer on a slide, marking up a slide, text messaging, or activating a vibrate mode are all sent via Node.js. Node.js broadcasts a signal to a selectable subset of audience devices using a multicasting protocol such as TCP/IP multicasting. In support of signalling, Node.js may be used to acquire coordinates (in the case of laser pointer and mark ups), text (in the case of Q&A or other text messaging) or other signals (in the case of vibrate or nudge).

Node.js uses an event-driven, non-blocking I/O model that makes it lightweight and efficient. Node.js is thus considered particularly useful for data-intensive real-time applications that run across distributed devices. In the present case, communications from a user device to the Node.js server trigger an event to communicate with other user devices as needed.

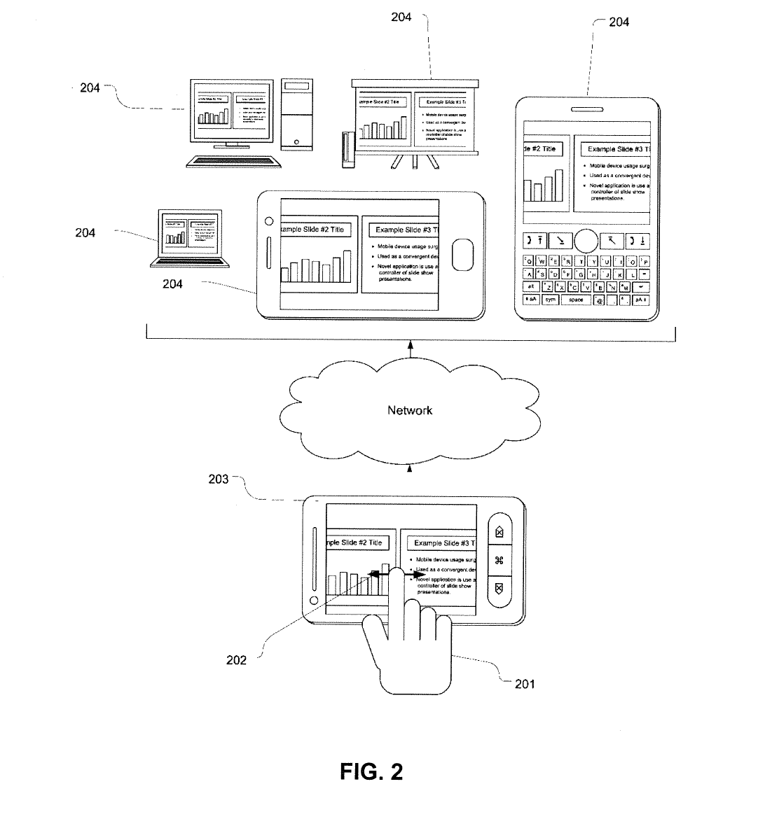

In one instance, the present invention provides means for a user (typically the presenter/host) to control a one to many presentation. This interaction is intermediated by a server across a network. In an embodiment, referring to FIG. 2, this is performed on a slide show (shown on device 204) by utilizing swipe motions with a fingertip 201 on a mobile device 202 on or alternatively with a stylus on a touch sensitive display in any supported orientation on the host's smartphone or other mobile device. These display instructions can then be conveyed to the participant devices to govern the flow of the presentation images they see. In doing so, slides, presented as images, can be displayed one after the other or in reverse direction in the host's device 202 with options to advance to a particular location. Selected slides are mirrored on host's device display 203 and that of audience devices 204. This method in the present invention provides the benefit of an intuitive user interface for presentation control.

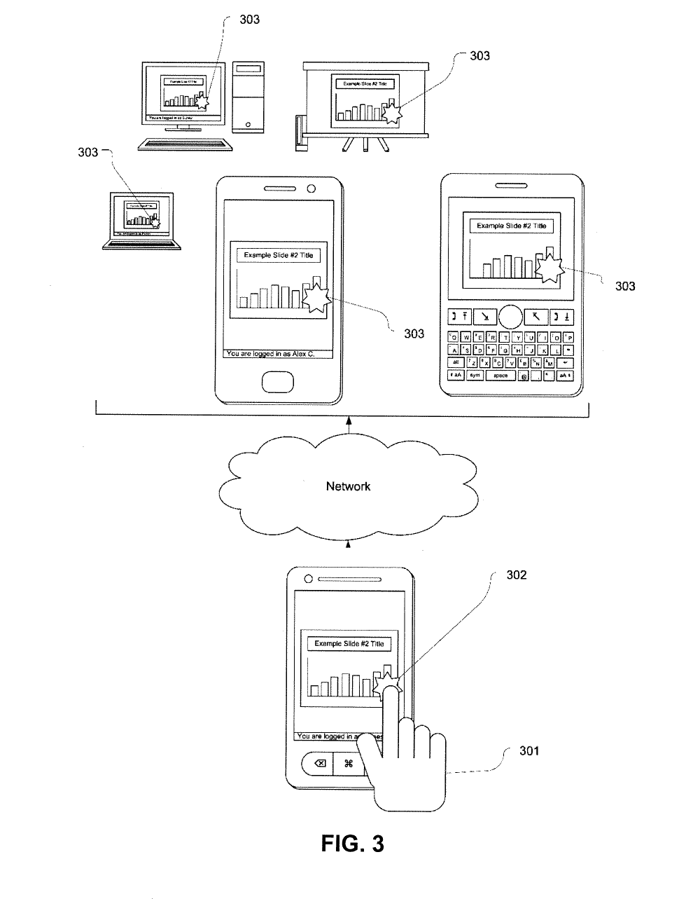

In another instance, the present invention provides means to direct participants' attention to an area of the display. This interaction is intermediated by a server across a network. In such an embodiment, referring to FIG. 3, this is performed by touching the host's touch sensitive smartphone display with a fingertip 301 or stylus (not shown) to control location of a visual cue. This is a one to many interaction. Depending on configuration, this cue may persist unless otherwise moved or removed. The cue, which utilizes coordinates provided by the host device 302 via the server for placement, is overlaid on or beside the slide in the audience devices 303. Since slides are presented as images, the image does not have to be rebroadcast every time the cue moves. Presentation and location of the visual cue on the host device 302 is mirrored on participants' displays 303. In traditional methods, a laser pointer is used on a projected image. In the present method, the user experience is similar, as the presentation is highlighted (like a laser pointer) on the smartphone display. The present invention thus combines the effects of a slide show controller and presentation tool.

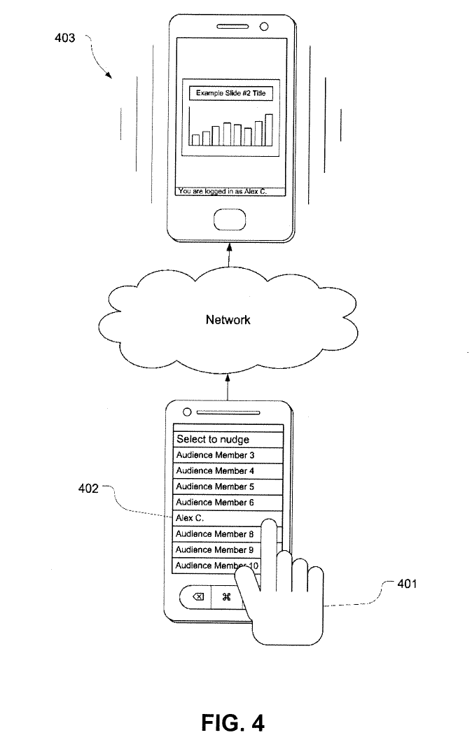

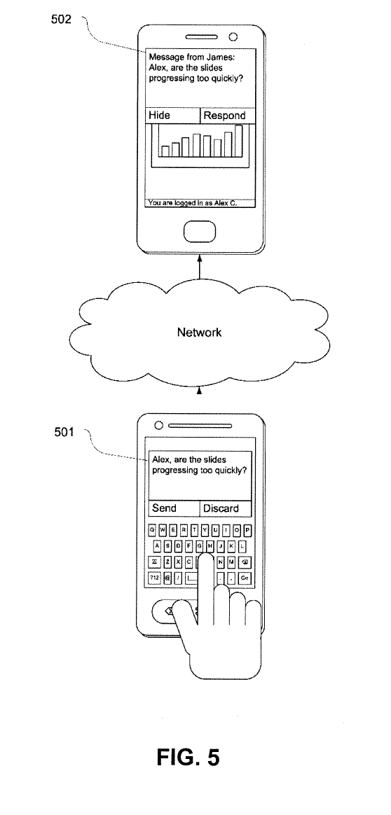

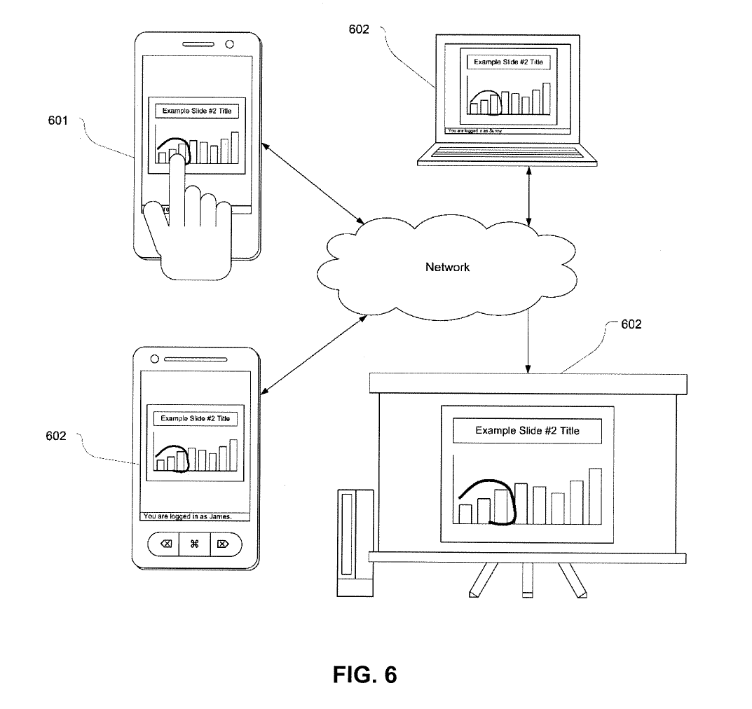

In another instance, the present invention provides means to participants to select and message all other or selected participants. This can be one to one or one to many. This interaction is intermediated by a server across a network. For example, this feature may use remotely activated indicators (such as the vibrate mode commonly found in smartphones) which has the benefit of providing a discrete non-verbal reminder. In FIG. 4, the host 401 selects an audience member 402 whose smartphone vibrates 403. Users may be able to pass text and other messages using input capabilities available on the smartphone (such as a keyboard), thus providing the benefit of integrated communications. In FIG. 5, a participant creates a text message 501 which can be sent and displayed in the recipient's client device 502. Messaging brings the benefit of interactivity to the presentation. In another instance, the present invention provides means to conduct an interactive white board session by the host to all other or selected participants. This interaction is intermediated by a server across a network. Interaction is many to many and bidirectional on supported devices. In one embodiment, referring to FIG. 6, all participants use their smartphones' input capabilities such as keyboard or touch display to edit or mark up information in common documents 601 while mirrored on other participants' displays 602. Where applicable, text and graphical markups, by using coordinates provided by the host device via the server for placement, can be overlaid on or beside the slide in the audience devices. Since slides are presented as images, the image does not have to be rebroadcast every time markups change. Note that comments, mark-ups and messaging may be optional permissions that can be disabled depending on host/organizer (or in some cases, participant) preferences.

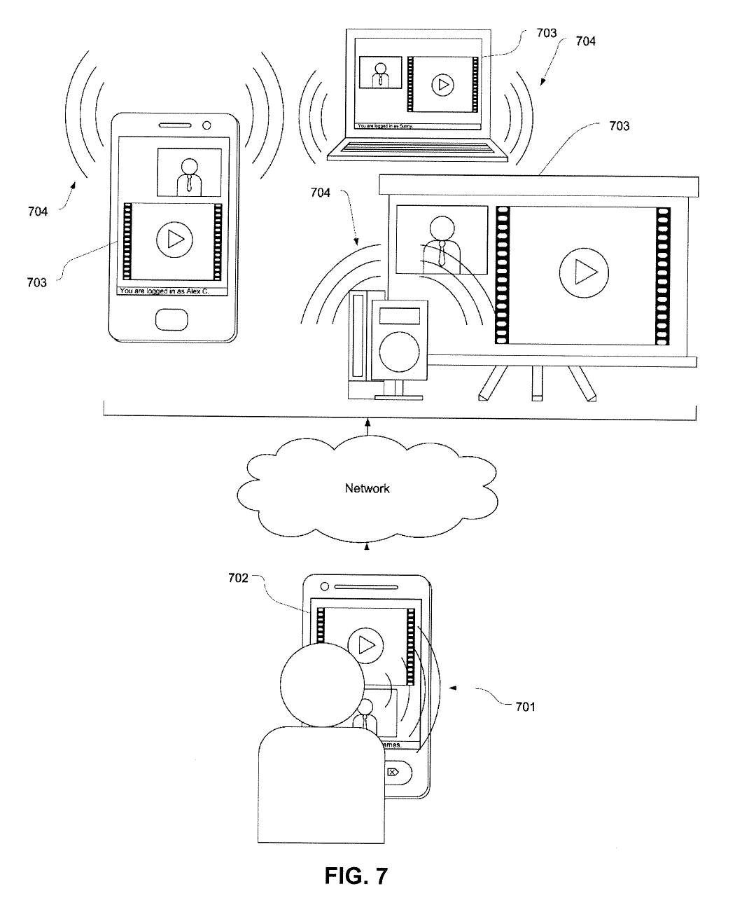

In another instance, the present invention provides means to transmit multimedia content including voice, video, 3D and emerging media types as part of the presentation. This interaction is intermediated by a server across a network. In an embodiment, referring to FIG. 7, the host uses a smartphone's camera and microphone 701 in conjunction with prepared written and graphical material to transmit enriched information (i.e. ancillary material) 702 to the audience who see 703 and hear 704 the multimedia presentation. This is a one to many interaction. This has the benefit of facilitating greater comprehension by the audience.

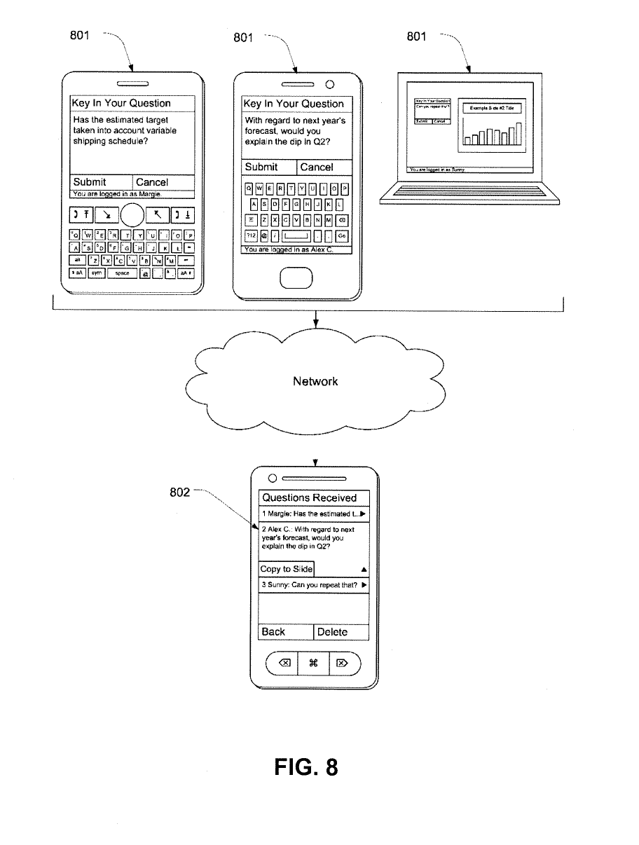

In yet another instance, the present invention provides means for participants to submit questions or comments at any time during the presentation. This interaction is intermediated by a server across a network. In an embodiment, referring to FIG. 8, the users add their comments through their respective presentation interactivity interfaces on their client devices (e.g. into a form made available by the software). The system activates a control to transmit the comments 801 such that they accumulate in a queue to which the host can voluntarily respond and manage 802. This is a many to one interaction. Answering questions typically occurs at the conclusion of the presentation which in traditional methods had potential to be disorganized. The present invention has the benefit of permitting the presentation event to occur in an efficient manner.

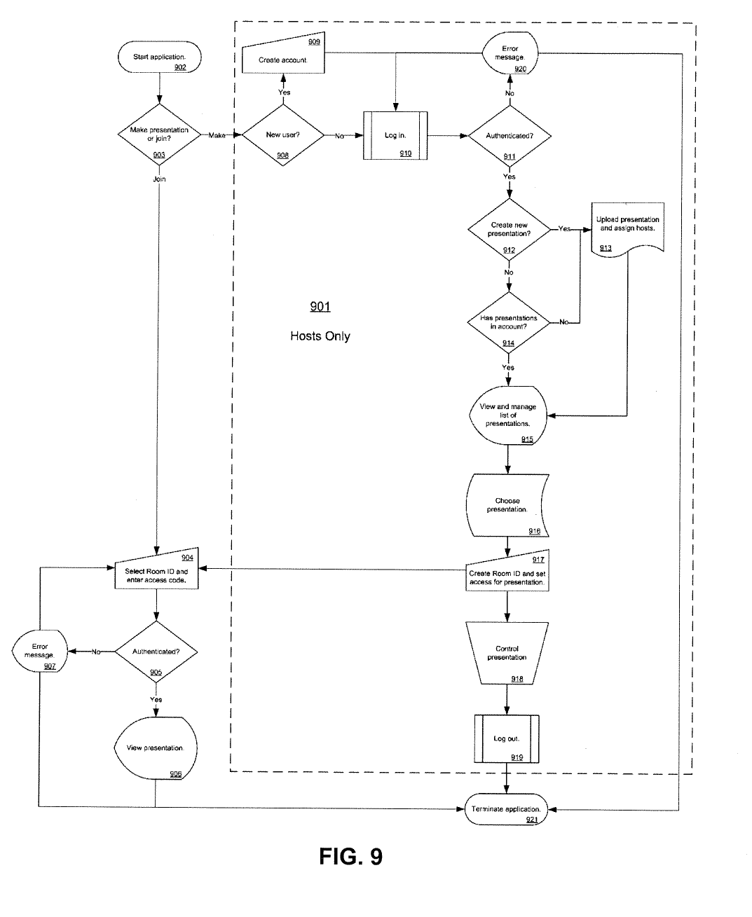

FIG. 9 depicts certain core business logic associated with participant interactions in the preferred embodiment of the present invention. There is a large portion which is preferably applicable only to hosts 901. For audience members, it is a simpler process with fewer activities. All participants start by activating the application 902. An option is provided whereby the participant may choose either to make a presentation (be a host) or join a presentation (be part of the audience) 903.

Referring to FIG. 9, if the participant chooses to be an audience member, the participant chooses a room (the virtual space for the presentation) available from a displayed list or directly inputs the room identification along with, optionally, an access code 904, which could be a password, biometric input, or an input from another access device such as a fob. In an alternative embodiment, a person could become an audience member by accepting an invitation extended via a social networking site such as Facebook. The access code may be of various forms but in a preferred embodiment is a password. The room identification and matching pass code is compared in a hash table in a database. For the audience, this does not necessarily constitute a full, conventional log in. If room and code pair is authenticated 905, the audience member is permitted access to the presentation gaining the privilege to view the presentation along with features available for such user role 906. Since this use case is shared by host and audience, features available is configurable and depends on the user role. If the would-be audience had unsuccessfully accessed the room, an error message is displayed 907. Options available are re-attempts 904 or ending the application 921.

Again referring to FIG. 9, if the participant chooses to be a host (presenter), the would-be host is presented with an option 908 to log in or, if a new user, to create an account 909. When creating an account, at minimum, an identification and access code are required. In a preferred embodiment, this is a user name and password. Only account holders may create or upload presentations into a secure library, which can later be accessed (for example, to use the contents to create new presentations). In possession of a user identification and access code, a log in may be attempted 910. If authenticated 911, the host is given the option to create a new presentation 912. This may involve directly creating one within the application or uploading an existing file 913. In a preferred embodiment, the file type is in PDF (Portable Document Format) or is transformed to PDF. For easiest handling, the PDF file may be converted to a series of images and delivered as images to the clients.

Generally, uploaded presentations (a first data set) are transformed into a second data set. For example, a presentation uploaded in Microsoft PowerPoint format may be transformed to PDF format. The transformation can be a unity transformation i.e. the first data set may be the same as the second data set. Use of PDF has the benefit of being more consistently rendered by a wide range of devices. By default, the presentation creator can host the presentation (create a room). However, the creator has the option to assign other registered users as hosts to new or existing presentations such that there can be more than one host of a given presentation. Other document management features (permissions) may include the ability to delete presentations 915. The host will have at this point one or more presentations in a library associated with the host's account 914. The host may browse or search for a presentation 915 and select it 916. The host then proceeds to associate the selected presentation with a room and access code 917 for the audience and possibly other hosts. The host may proceed to view the presentation 906 with pre-requisite room selection and pass code authentication 904 905 obviated. In addition, the host has the option to control the same presentation 918. The host may log out 919 and terminate the application 921. If in the host log in process, authentication stage 911 was unsuccessful, an error message is displayed 920. Options available are re-attempts 910 or ending the application 921.

The intent of the application is to cover all such combinations and permutations not listed here but that are obvious to persons skilled in the art. The above examples are not intended to be limiting, but are illustrative and exemplary.

The examples noted here are for illustrative purposes only and may be extended to other implementation embodiments. While several embodiments are described, there is no intent to limit the disclosure to the embodiment(s) disclosed herein. On the contrary, the intent is to cover all alternatives, modifications, and equivalents obvious to those familiar with the art.

What is claimed is:

1. A method of receiving and interacting with a set of presentation images by a user on a mobile device, during a presentation given by a presenter to a plurality of participants, the method comprising the steps of:
receiving on the mobile device from a presentation server a set of presentation images;
receiving a first display instruction from the presenter via the server;
displaying the presentation images through an interactivity interface on the device taking into account the first display instructions as permitted by the capabilities of the mobile device, the presentation images having been rendered locally on the mobile device; and
receiving a second display instruction from the presenter via the server and changing the appearance or pacing of the presentation images displayed on the interactivity interface without reloading the presentation images from the presentation server.

2. The method of claim 1, wherein the first and second display instructions comprise instructions related to an order or playback of the presentation images, highlighting of a portion of an image, or initiating a playback of a multimedia component.

3. The method of claim 1, further comprising receiving ancillary material from the presenter, which is rendered as an overlay on at least one of the presentation images displayed on the interactivity interface.

4. The method of claim 3, wherein the ancillary material comprises at least one of a graphical image, text, multimedia component, photograph, voice or video call generated at least in part by the presenter during the presentation.

5. The method of claim 3, wherein receiving the ancillary material does not require reloading the presentation images on the device.

6. The method of claim 1, further comprising receiving messaging from the presenter or a participant during the presentation while the presentation images are being displayed.

7. The method of claim 6, wherein the messaging comprises a text message, a vibrate signal, a voice or video call.

8. The method of claim 6, wherein the messaging does not obscure the presentation image being displayed.

9. The method of claim 6, wherein the messaging is received as a broadcast across a plurality of participant devices.

10. The method of claim 6, wherein the messaging is received as a private, one-to-one message.

11. The method of claim 1, further comprising permitting input from the user via the interactivity interface while the presentation images are being displayed.

12. The method of claim 11, wherein the input comprises a message, a highlight of an item on the presentation images, a graphical image or multimedia component generated by the user during the presentation.

13. The method of claim 11, wherein the input includes a request to transmit the input to the presenter, or another participant.

14. The method of claim 11, wherein the input includes a request to broadcast the input to all of the participants.

15. The method of claim 11, wherein the input is received via a touch screen on the device.

16. The method of claim 11, wherein the input appears as an overlay with the presentation image on the user's device while the input is being generated by the user.

17. The method of claim 11, wherein the input does not alter the local copy of the presentation images.
